(19) United States
(12) Patent Application Publication
(10) Pub. No.: US 2015/0161345 A1
(43) Pub. Date: Jun. 11, 2015

(54) SECURE MESSAGING SERVICES

(71) Applicant: Verizon Patent and Licensing Inc., Basking Ridge, NJ (US)

(72) Inventor: Peter S. TIPPETT, Great Falls, VA (US)

(73) Assignee: Verizon Patent and Licensing Inc., Basking Ridge, NJ (US)

(21) Appl. No.: 14/100,259

(22) Filed: Dec. 9, 2013

(51) Int. Cl. G06F 19/00

(52) U.S. Cl. CPC G06F 19/3425; G06F 19/322

(57) ABSTRACT

A device receives, from a first user device associated with a user, a request to access a secure messaging service provide by the device, authenticates the user based on credentials provided in the request, and receives a search request for users of the secure messaging service. The device identifies authentic users of the secure messaging service based on the search request; provides, to the first user device, information associated with the authentic users; receives a message addressed to a particular user of the authentic users; analyzes the message to determine whether the message includes information for identifying the user or the particular user; stores the information for identifying the user or the particular user; formats the message into a format that is understood by a second user device associated with the particular user; encrypts the formatted message; and provides the encrypted and formatted message to the second user device.

### BACKGROUND

Healthcare providers, such as doctors, pharmacies, hospitals, etc., provide a variety of healthcare services to beneficiaries, such as patients and consumer organizations that maintain personal health records (PHRs). Sometimes the healthcare providers may need to provide healthcare information to other healthcare providers associated with the beneficiaries. For example, an emergency room doctor may need to provide a patient's X-rays to the patient's primary care doctor. The healthcare information may include, for example, discharge summaries when patients are discharged from a hospital; reasons for a referral; consultant reports to referring doctors; medication lists; imaging test results; lab results; a care plan from specialists; discharge instructions; a list of follow-up appointments, procedures, tests, and referrals; a medication allergy list; a problem list; etc.

However, due to privacy and security rules and concerns, most healthcare providers share the healthcare information with other healthcare providers via manual communication methods, such as mail or hand delivery of paper containing the healthcare information. Such manual communication methods are inefficient, slow, and expensive. Furthermore, many healthcare providers maintain a database of electronic health records (EHRs) for their patients. For such healthcare providers, the paper containing the healthcare information may need to be imaged and converted (e.g., via optical character recognition (OCR)) before being added to the database of EHRs.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of a device that may correspond to one or more of the devices of the environment depicted in FIG. 2;

FIG. 4 is a flow chart of an example process for creating and configuring a profile for a secure messaging platform;

FIGS. 5A-5D are diagrams of an example relating to the example process shown in FIG. 4;

FIGS. 6A and 6B provide a flow chart of an example process for securely exchanging a message via a secure messaging platform; and

FIGS. 7A-7K are diagrams of an example relating to the example process shown in FIGS. 6A and 6B.

### DETAILED DESCRIPTION OF PREFERRED EMBODIMENTS

The following detailed description refers to the accompanying drawings. The same reference numbers in different drawings may identify the same or similar elements.

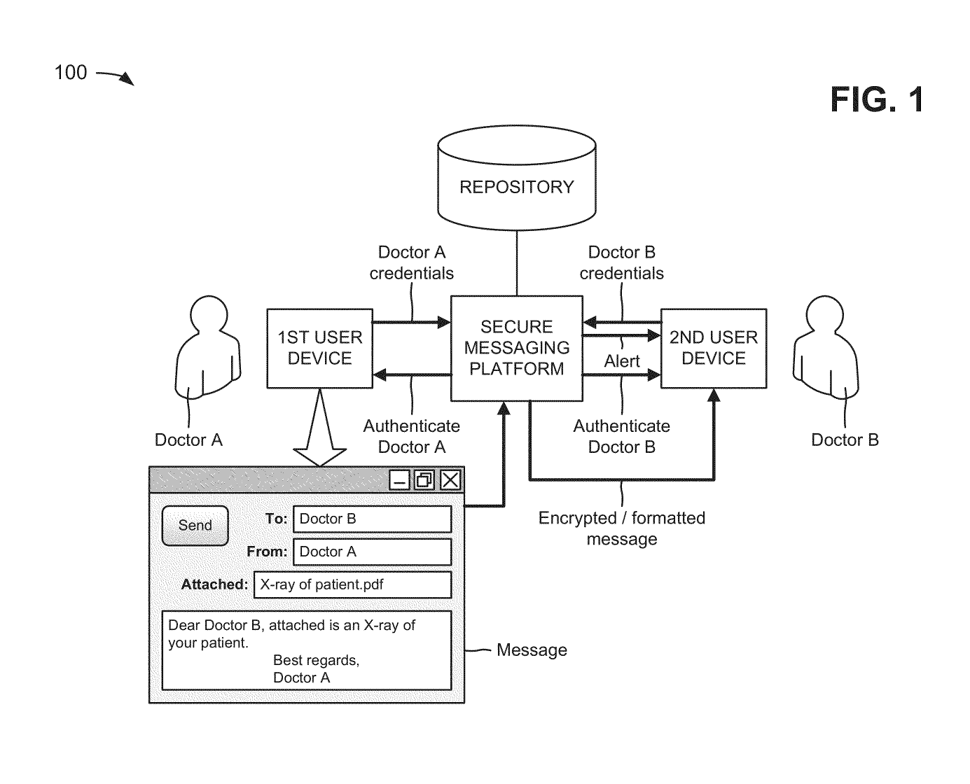

FIG. 1 is a diagram of an overview of an example implementation 100 described herein. As shown, a first user device, a second user device, a secure messaging platform, and a repository may be connected together via network (not shown in FIG. 1). The first user device may be associated with a first user (e.g., Doctor A) and the second user device may be associated with a second user (e.g., Doctor B). The secure messaging platform may enable users (e.g., healthcare providers) to securely share information (e.g., healthcare information) electronically. The repository may store information used to identify and/or authenticate users (e.g., business associate agreements with the users), healthcare information, etc.

In example implementation 100, assume that Doctor A wishes to securely share an X-ray of a patient with Doctor B. Further, assume that Doctor A provides, via the first user device, a request to access the secure messaging platform, and credentials (e.g., a user name, a password, etc.), associated with Doctor A, to the secure messaging platform, as shown in FIG. 1. The secure messaging platform may compare Doctor A's credentials with information (e.g., stored in the repository) that is used to identify and/or authenticate users of the secure messaging platform. If Doctor A's credentials match information in the repository, the secure messaging platform may authenticate Doctor A, as further shown in FIG. 1.

After Doctor A is authenticated, Doctor A may generate a message via the first user device. The message may be addressed to Doctor B and may include an attached document (e.g., an image of an X-ray of a patient). The message may also include information addressed to Doctor B, such as, for example, “Dear Doctor B, attached is an X-ray of your patient.” Doctor A may instruct the first user device to provide the message to the secure messaging platform, and the secure messaging platform may receive the message. In some implementations, the secure messaging platform may analyze the message to determine information identifying Doctor A and/or Doctor B that may not be included in the repository. For example, if the X-ray indicates a hospital number, a hospital name, a patient name, etc., the secure messaging platform may associate this information with Doctor A and/or Doctor B and may store the information in the repository. The secure messaging platform may utilize such information to authenticate Doctor A and/or Doctor B at a later time.

The secure messaging platform may encrypt the message in accordance with particular standards (e.g., Health Insurance Portability and Accountability Act (HIPAA) regulations). The secure messaging platform may format the message into a format that is understood by the second user device associated with Doctor B. For example, if Doctor B utilizes a system that stores EHRs in a particular format, the secure messaging platform may format the message and the attached X-ray into a format understood by Doctor B's system. The secure messaging platform may provide, to the second user device, an alert indicating that there is a message for Doctor B on the secure messaging platform, as further shown in FIG. 1.

Doctor B may provide, based on the alert and via the second user device, a request to access the secure messaging platform, and credentials (e.g., a user name, a password, etc.), associated with Doctor B, to the secure messaging platform, as shown in FIG. 1. The secure messaging platform may compare Doctor B's credentials with information (e.g., stored in the repository) that is used to identify and/or authenticate users of the secure messaging platform. If Doctor B's credentials match information in the repository, the secure messaging platform may authenticate Doctor B, as further shown in FIG. 1. After Doctor B is authenticated, the secure messaging platform may provide the encrypted and formatted message to the second user device, and the second user device may display the message to Doctor B. In some implementations, Doctor B may instruct the second user device to store the message and/or the attached X-ray with information associated with the patient.

Such a secure messaging platform may enable information, such as healthcare information, to be securely shared among users (e.g., healthcare providers) in accordance with particular standards (e.g., HIPAA regulations). The secure messaging platform may ensure that every user is registered and authenticated before any information is shared among users. The secure messaging platform may further ensure that the information is shared in a format that is understandable by a receiving user. Thus, users may not worry about formatting information or complying with particular standards since the secure messaging platform handles such tasks.

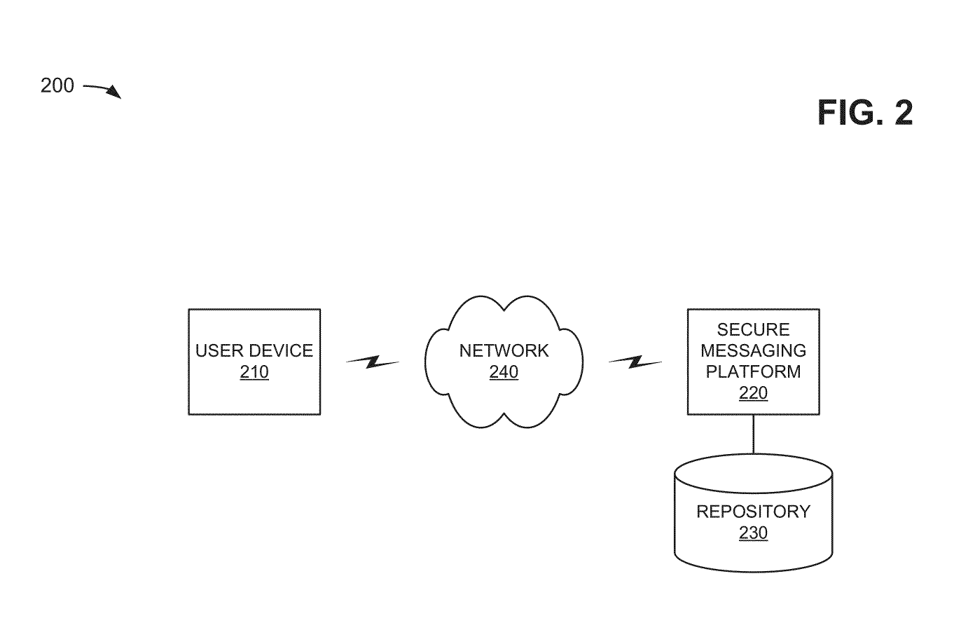

FIG. 2 is a diagram of an example environment 200 in which systems and/or methods described herein may be implemented. As illustrated, environment 200 may include a user device 210, a secure messaging platform 220, a repository 230, and a network 240. Devices/networks of environment 200 may interconnect via wired and/or wireless connections.

User device 210 may include a device that is capable of communicating over network 240 with secure messaging platform 220 and/or repository 230. In some implementations, user device 210 may include a radiotelephone; a PCS terminal that may combine, for example, a cellular radiotelephone with data processing and data communications capabilities; a smart phone; a PDA that can include a radiotelephone, a pager, Internet/intranet access, etc.; a laptop computer; a tablet computer; a desktop computer; a workstation computer; a personal computer; a landline telephone; or other types of computation and communication devices.

Secure messaging platform 220 may include one or more personal computers, workstation computers, server devices, or other types of computation and communication devices. In some implementations, secure messaging platform 220 may enable users of user devices 210 to securely share information electronically. In some implementations, secure messaging platform 220 may enable healthcare providers (e.g., doctors, pharmacies, hospitals, etc.) to securely and electronically share healthcare information, such as, for example, discharge summaries; reasons for a referral; consultant reports to referring doctors; medication lists; imaging test results; lab results; a care plan from specialists; etc. In some implementations, secure messaging platform 220 may enable other types of users (e.g., financial institutions, corporations, government agencies, etc.) to securely and electronically share information.

Repository 230 may include one or more data structures, such as databases, tables, lists, arrays, etc. In some implementations, repository 230 may store information used to identify and/or authenticate users, healthcare information, information associated with particular regulations (e.g., HIPAA regulations), etc. In some implementations, the information used to identify and/or authenticate users may include agreements (e.g., business associate agreements) entered into by the users with secure messaging platform 220; license information (e.g., drivers license numbers, medical license numbers, etc.) associated with the users; demographic information (e.g., name, address, telephone number, etc.) associated with the users; etc. In some implementations, repository 230 may be included in secure messaging platform 220 or may be separate from secure messaging platform 220.

Network 240 may include a network, such as a local area network (LAN), a wide area network (WAN), a metropolitan area network (MAN), a telephone network, such as the Public Switched Telephone Network (PSTN) or a cellular network, an intranet, the Internet, or a combination of networks.

The number of devices and/or networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

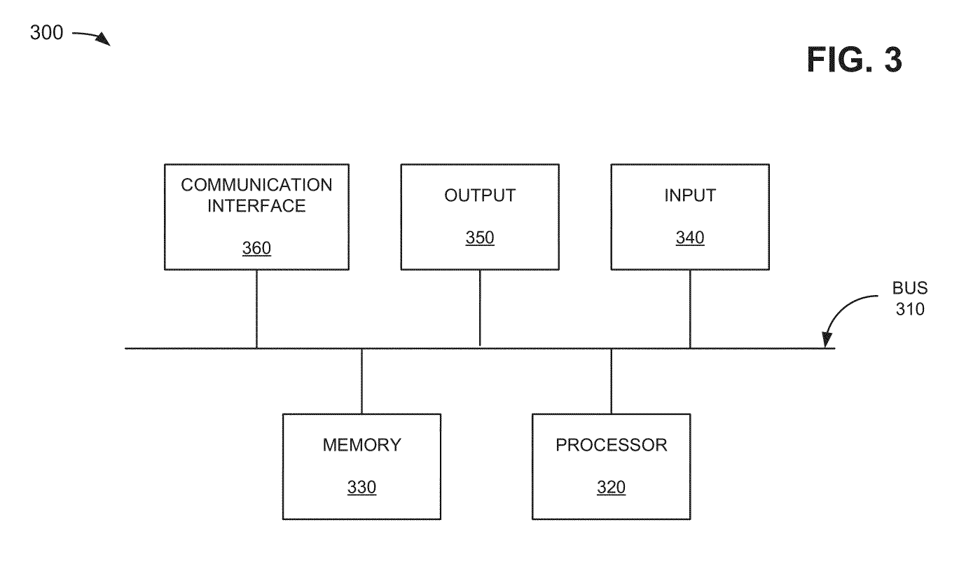

FIG. 3 is a diagram of example components of a device 300 that may correspond to one or more of the devices of environment 200. In some implementation, one or more of the devices of environment 200 may include one or more devices 300 or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit, etc.), a microprocessor, and/or any processing component (e.g., a field-programmable gate array (FPGA), an application-specific integrated circuit (ASIC), etc.) that interprets and/or executes instructions, and/or that is designed to implement a particular function. In some implementations, processor 320 may include multiple processor cores for parallel computing. Memory 330 may include a random access memory (RAM), a read only memory (ROM), and/or another type of dynamic or static storage component (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, etc.). Output component 350 may include a component that outputs information from device 300 (e.g., a display, a speaker, one or more light-emitting diodes (LEDs), etc.).

Communication interface 360 may include a transceiver-like component, such as a transceiver and/or a separate receiver and transmitter, which enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (RF) interface, a universal serial bus (USB) interface, a high-definition multimedia interface (HDMI), or the like.

Device 300 may perform various operations described herein. Device 300 may perform these operations in response to processor 320 executing software instructions included in a computer-readable medium, such as memory 330. A computer-readable medium may be defined as a non-transitory memory device. A memory device may include memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided as an example. In practice, device 300 may include additional components, fewer components, different components, or differently arranged components than those shown in FIG. 3. Additionally, or alternatively, one or more components of device 300 may perform one or more functions described as being performed by another one or more components of device 300.

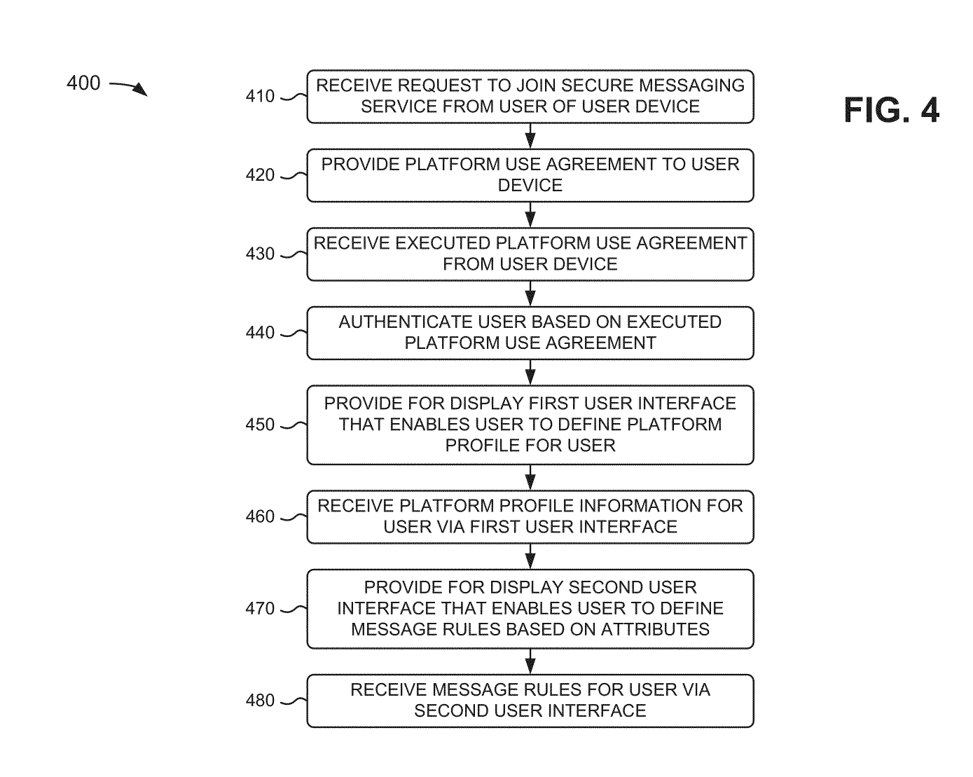

FIG. 4 is a flow chart of an example process 400 for creating and configuring a profile for a secure messaging platform. In some implementations, one or more process blocks of FIG. 4 may be performed by secure messaging platform 220. In some implementations, one or more process blocks of FIG. 4 may be performed by another device or a group of devices separate from or including secure messaging platform 220.

As shown in FIG. 4, process 400 may include receiving a request to join a secure messaging service from a user of a user device (block 410). For example, a user (e.g., a doctor, a hospital, a pharmacy, etc.) associated with user device 210 may wish to join a secure messaging service provided by secure messaging platform 220. In some implementations, the secure messaging service may enable the user to securely share information (e.g., healthcare information) with other users of secure messaging platform 220 in accordance with particular regulations (e.g., HIPAA regulations). In some implementations, in order to join the secure messaging service, the user may utilize user device 210 to access a web page provided by secure messaging platform 220. The web page may ask the user to provide credentials (e.g., a user name and password) for accessing the secure messaging service, or may ask whether the user wants to join the secure messaging service.

If the user has not previously joined the secure messaging service, the user may utilize the web page to join the secure messaging service. In some implementations, the user may select a mechanism (e.g., a button, an icon, a link, a menu item, etc.) provided by the web page that, when selected, may indicate that the user wants to join the secure messaging service. If the user selects the mechanism, via user device 210, a request to join the secure messaging service may be generated by user device 210 and provided to secure messaging platform 220. Secure messaging platform 220 may receive the request to join the secure messaging service.

As further shown in FIG. 4, process 400 may include providing a platform use agreement to the user device (block 420). For example, based on the request to join the secure messaging service, secure messaging platform 220 may provide a platform use agreement to user device 210. In some implementations, the platform use agreement may include a business associate agreement (BAA) between HIPAA covered entities (e.g., healthcare providers, pharmacies, healthcare plans, healthcare insurers, healthcare clearinghouses, etc.) and business associates (e.g., persons receiving, transmitting, and/or processing healthcare information for the covered entities). The BAA may include a contract between a covered entity (e.g., the user) and a business associate (e.g., secure messaging platform 220) that protects healthcare information in accordance with HIPAA guidelines. The BAA may explicitly define how a business associate will report and respond to a data breach, including data breaches that are caused by a business associate's subcontractors. In some implementations, the BAA may request that the user provide information (e.g., identification information, a physical address, a telephone number, license information, etc.) in the BAA. In some implementations, the platform use agreement may include other types of agreements that protect information provided by the user (e.g., a financial institution) in accordance with particular regulations (e.g., regulations associated with financial institutions).

User device 210 may receive the platform use agreement from secure messaging platform 220, and may display the platform use agreement to the user. The user may review the platform use agreement, and, if the user agrees with the terms of the platform use agreement, may execute the platform use agreement. In some implementations, the user may execute the platform use agreement by electronically signing the platform use agreement via user device 210.

As further shown in FIG. 4, process 400 may include receiving the executed platform use agreement from the user device (block 430). For example, after the user executes the platform use agreement, the user may instruct user device 210 to provide the executed platform use agreement to secure messaging platform 220. In some implementations, user device 210 may automatically provide the executed platform use agreement to secure messaging platform 220 when the user executes the platform use agreement. In some implementations, the user may select a mechanism (e.g., a button, an icon, a link, a menu entry, etc.) that, when selected, may cause user device 210 to provide the executed platform use agreement to secure messaging platform 220. Secure messaging platform 220 may receive the executed platform use agreement, and may store the executed platform use agreement in repository 230. In some implementations, secure messaging platform 220 may extract information provided by the user in the platform use agreement, and may store the extracted information in repository 230. The extracted information may be used by secure messaging platform 220 to begin creation of a profile for the user. The extracted information may include identification information of the user (e.g., a name, an address, etc.), license information of the user (e.g., a doctor's license number, a hospital license number, etc.), and other information associated with the user (e.g., a mobile device number, a social security number, etc.).

As further shown in FIG. 4, process 400 may include authenticating the user based on the executed platform use agreement (block 440). For example, secure messaging platform 220 may utilize the extracted information from the platform use agreement to authenticate the user. In some implementations, secure messaging platform 220 may compare the extracted information with information stored in repository 230. For example, if the user provided a name, an address, and a doctor's license number in the platform use agreement, secure messaging platform 220 may compare that information to information stored in repository 230 or provided by other resources (e.g. a medical directory). In this example, secure messaging platform 220 may determine whether the name, the address, and the doctor's license number, provided in the extracted information, match a name, an address, and a doctor's license number stored in repository 230 or provided by the other resources.

If secure messaging platform 220 determines that the information matches, secure messaging platform 220 may authenticate the user. In some implementations, secure messaging platform 220 may determine that the user is an authentic doctor based on the name, the address, and the doctor's license number provided in the extracted information. In some implementations, secure messaging platform 220 may request additional information from the user before authenticating the user. For example, secure messaging platform 220 may request a social security number, a driver's license number, a passport number, etc. from the user, and may authenticate the user based on the extracted information and/or the additional information.

As further shown in FIG. 4, process 400 may include providing for display a first user interface that enables the user to define a platform profile for the user (block 450). For example, secure messaging platform 220 may generate a user interface that enables the user to define profile information for the secure messaging service. Secure messaging platform 220 may provide the user interface to user device 210, and user device 210 may display the user interface to the user. In some implementations, the user interface may request a variety of profile information from the user, such as, for example, a user name, a password, a name, a physical address, an email address, a telephone number, etc. In some implementations, the user interface may include an online form with fields for receiving the user's input of the variety of profile information. The user may provide the profile information requested by the user interface.

As further shown in FIG. 4, process 400 may include receiving platform profile information for the user and via the first user interface (block 460). For example, after the user provides the profile information requested by the user interface, the user may instruct user device 210 to provide the profile information to secure messaging platform 220. In some implementations, the user interface may include a mechanism (e.g., a button, an icon, a link, a menu entry, etc.) that, when selected, may cause user device 210 to provide the profile information to secure messaging platform 220. Secure messaging platform 220 may receive the profile information from user device 210, and may associate the profile information with the profile of the user. In some implementations, secure messaging platform 220 may store the profile of the user in repository 230.

As further shown in FIG. 4, process 400 may include providing for display a second user interface that enables the user to define message rules based on attributes (block 470). For example, secure messaging platform 220 may generate another user interface that enables the user to define message rules, based on attributes, for the secure messaging service. Secure messaging platform 220 may provide the other user interface to user device 210, and user device 210 may display the other user interface to the user. In some implementations, the other user interface may enable the user to specify from whom (e.g., other doctors, hospitals, etc.) the user may receive messages via secure messaging platform 220; to specify that the user is only to receive messages via secure messaging platform 220 from other users who are located a particular distance from the user; to specify that the user is only to receive messages associated with a particular medical condition (e.g., a particular disease) via secure messaging platform 220; to specify that the user is only to receive messages via secure messaging platform 220 from doctors with a particular specialty (e.g., orthopedic doctors) or from doctors treating a particular medical condition; to specify which other users of secure messaging platform 220 may see the user's profile and information; etc. In some implementations, such message rules may enable formation of communities of users (e.g., doctors, patients, hospitals, etc.) that are well-defined and cohesive and, at the same time, completely anonymous.

In some implementations, the other user interface may enable the user to specify a user device and/or media via which to receive messages from secure messaging platform 220. For example, if the user is an emergency room doctor at a hospital, the doctor may specify that messages from particular emergency room personnel should be received by the doctor's mobile device and via a text message. This way the doctor may receive urgent messages from emergency room personnel quickly and easily. The doctor may further specify that less urgent messages from hospital administrators should be received by the doctor's desktop computer and via a message accessed from secure messaging platform 220.

As further shown in FIG. 4, process 400 may include receiving the message rules for the user via the second user interface (block 480). For example, after the user specifies the message rules requested by the other user interface, the user may instruct user device 210 to provide the message rules to secure messaging platform 220. In some implementations, the user interface may include a mechanism (e.g., a button, an icon, a link, a menu entry, etc.) that, when selected, may cause user device 210 to provide the message rules to secure messaging platform 220. Secure messaging platform 220 may receive the message rules from user device 210, and may associate the message rules with the profile of the user. In some implementations, secure messaging platform 220 may store the profile of the user, and the message rules, in repository 230.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

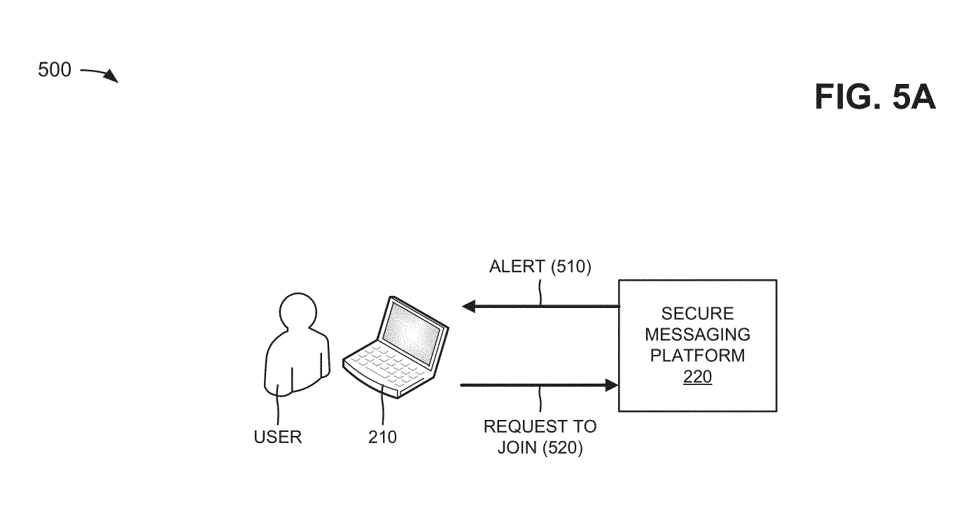

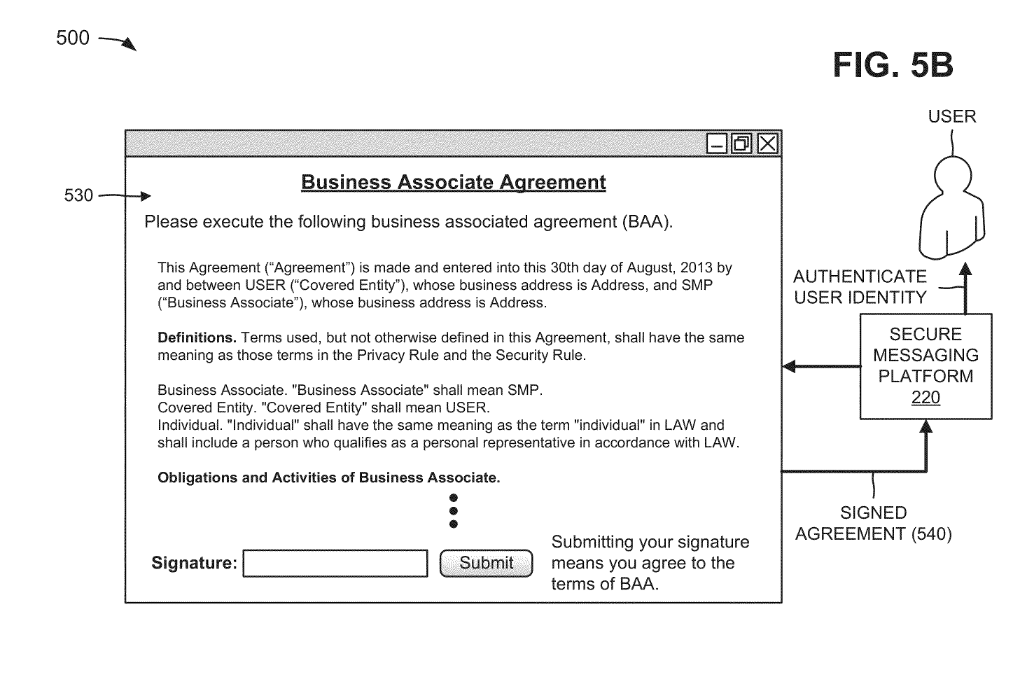

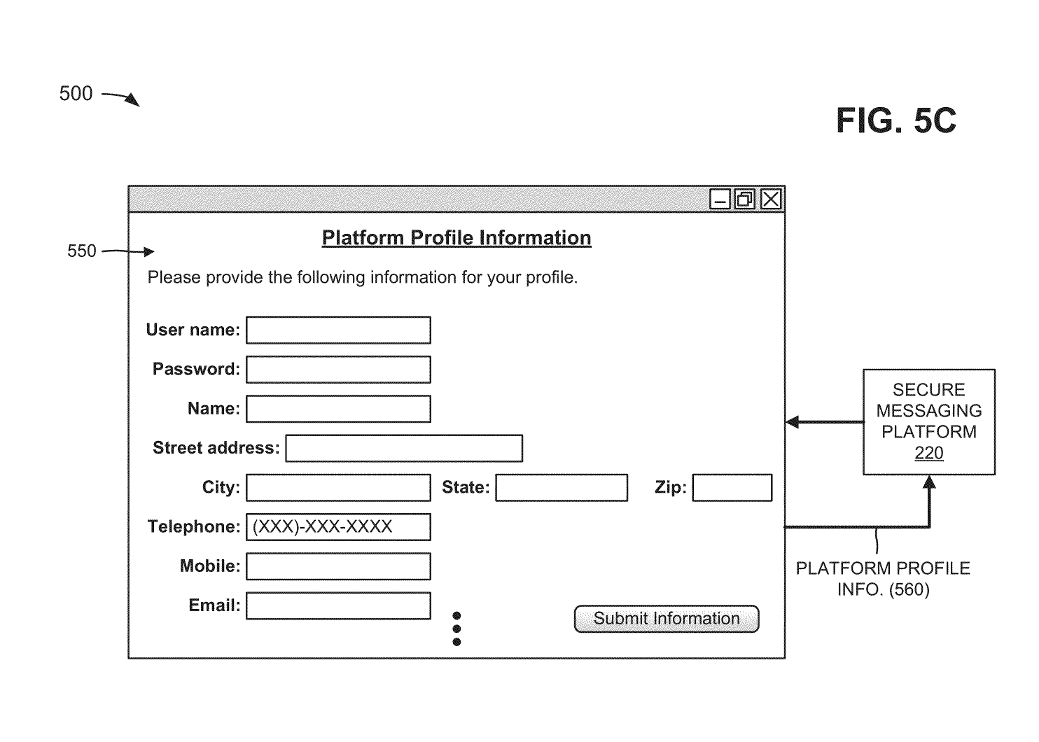

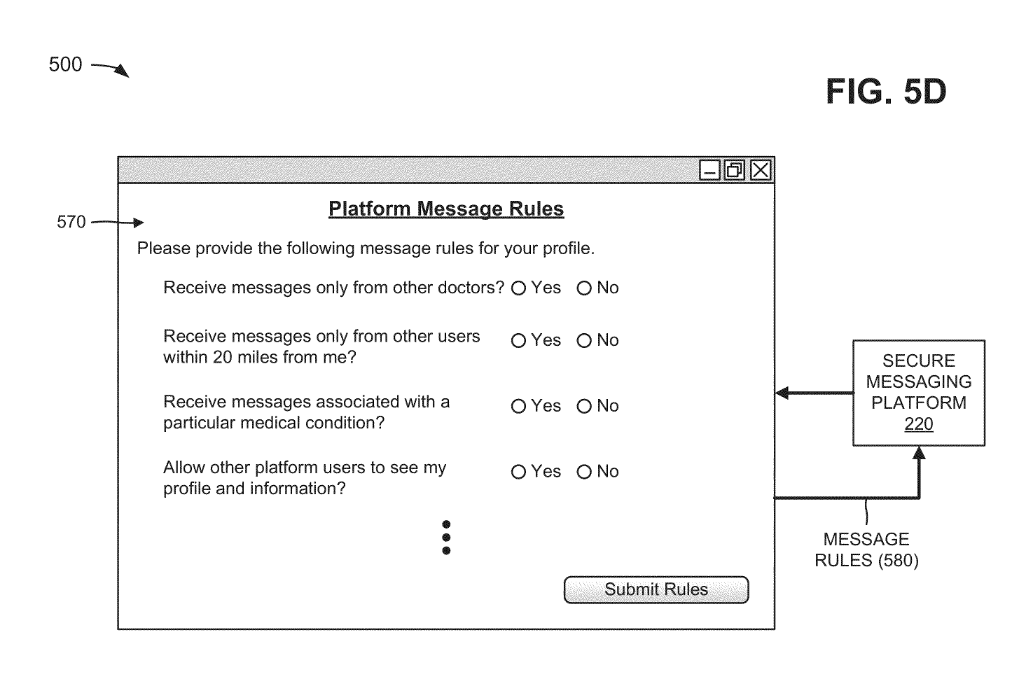

FIGS. 5A-5D are diagrams of an example 500 relating to example process 400 shown in FIG. 4. In example 500, assume that a user (e.g., USER) is associated with user device 210, as shown in FIG. 5A. In some implementations, even if the user is not subscribed to a secure messaging service provided by secure messaging platform 220, the user may still receive an alert 510 from secure messaging platform 220. Alert 510 may indicate that another user of secure messaging platform 220 wishes to provide a secure message to the user. In some implementations, the user may not receive alert 510 but still may wish to join or subscribe to the secure messaging service provided by secure messaging platform 220. In either instance, the user may utilize user device 210 to provide a request 520 to join the secure messaging service to secure messaging platform 220, as further shown in FIG. 5A. In some implementations, the user may utilize user device 210 to access a web page provided by secure messaging platform 220. The web page may ask whether the user wants to join the secure messaging service. Since the user has not previously joined the secure messaging service, the user may utilize the web page to provide request 520 to join the secure messaging service to secure messaging platform 220.

Based on request 520 to join the secure messaging service, assume that secure messaging platform 220 provides a platform use agreement to user device 210, as shown in a user interface 530 of FIG. 5B. As shown in user interface 530, assume that the platform use agreement includes a BAA between a covered entity (e.g., the user) and a business associate (e.g., secure messaging platform 220) that protects healthcare information in accordance with HIPAA guidelines. As further shown, the BAA may include a signature section and a Submit button. If the user agrees to the terms of the BAA, the user may provide a signature (e.g., /User Name/) in the signature section and may select the Submit button. In example 500, assume that the user utilizes user device 210 to sign the BAA and select the Submit button. When the user selects the Submit button, user device 210 may provide a signed platform use agreement 540 to secure messaging platform 220, as further shown in FIG. 5B.

Secure messaging platform 220 may receive signed platform use agreement 540, and may store signed platform use agreement 540. Secure messaging platform 220 may extract information provided by the user in the platform use agreement, such as, for example a name and address of the user, license information associated with the user, a telephone number of the user, etc. Secure messaging platform 220 may utilize the extracted information from the platform use agreement to authenticate the user's identity. In example 500, assume that the user provided a name, an address, a telephone number, and a doctor's license number in the platform use agreement. Secure messaging platform 220 may compare that information to information stored in repository 230 or provided by other resources in order to authenticate the user's identity. In example 500, assume that secure messaging platform 220 determines that the user is an authentic doctor based on the name, the address, the telephone number, and the doctor's license number provided in the extracted information, as further shown in FIG. 5B.

Once the user is authenticated, secure messaging platform 220 may generate a user interface 550 that enables the user to define profile information for the secure messaging service, as shown in FIG. 5C. Secure messaging platform 220 may provide user interface 550 to user device 210, and user device 210 may display user interface 550 to the user. As further shown in FIG. 5C, user interface 550 may request platform profile information 560 from the user, such as, for example, a user name, a password, a name, a street address, a city, a state, a zip code, a telephone number, a mobile telephone number, an email address, etc. In example 500, assume that the user provides platform profile information 560 requested by user interface 550, and selects a Submit Information button. When the user selects the Submit information button, user device 210 may provide platform profile information 560 to secure messaging platform 220, as further shown in FIG. 5C. Secure messaging platform 220 may receive platform profile information 560, and may associate platform profile information 560 with the profile of the user.

Secure messaging platform 220 may also generate a user interface 570 that enables the user to define message rules 580 for the secure messaging service, as shown in FIG. 5D. Secure messaging platform 220 may provide user interface 570 to user device 210, and user device 210 may display user interface 570 to the user. As further shown in FIG. 5D, user interface 570 may enable the user to elect to receive messages only from other doctors or only from other users who are located a particular distance from the user. User interface 570 may enable the user to elect to receive messages associated with a particular medical condition, and to specify whether other users may see the user's profile and information. After the user specifies message rules 580 requested by user interface 570, the user may select a Submit Rules button that, when selected, causes user device 210 to provide message rules 580 to secure messaging platform 220, as further shown in FIG. 5D. Secure messaging platform 220 may receive message rules 580 from user device 210, and may associate message rules 580 with the profile of the user.

As indicated above, FIGS. 5A-5D are provided merely as an example. Other examples are possible and may differ from what was described with regard to FIGS. 5A-5D.

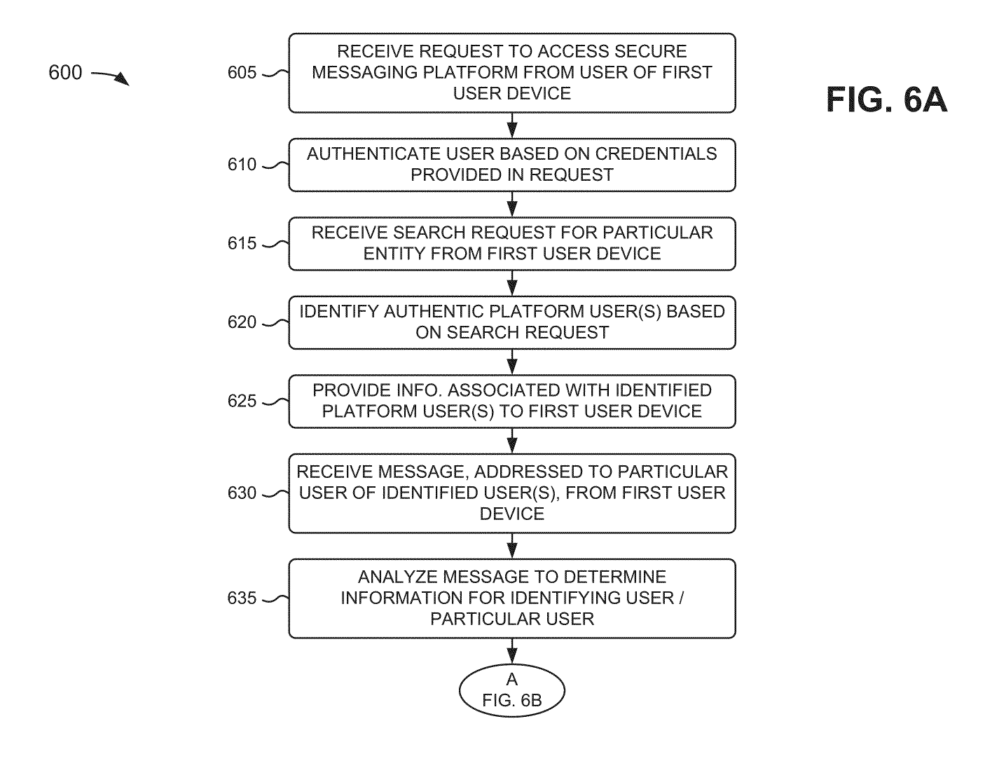

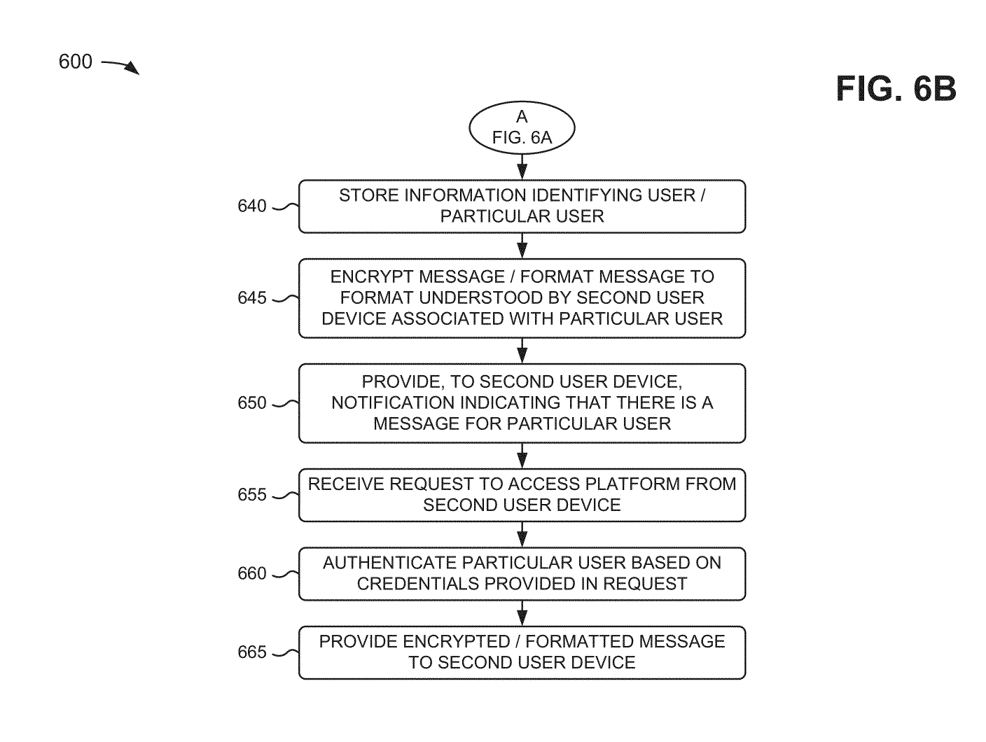

FIGS. 6A and 6B provide a flow chart of an example process 600 for securely exchanging a message via a secure messaging platform. In some implementations, one or more process blocks of FIGS. 6A and 6B may be performed by secure messaging platform 220. In some implementations, one or more process blocks of FIGS. 6A and 6B may be performed by another device or a group of devices separate from or including secure messaging platform 220.

As shown in FIG. 6A, process 600 may include receiving a request to access a secure messaging platform from a user of a first user device (block 605). For example, a user (e.g., a doctor, a hospital, a pharmacy, etc.) associated with user device 210 may wish to access a secure messaging service provided by secure messaging platform 220. In some implementations, the secure messaging service may enable the user to securely share information (e.g., healthcare information) with other users of secure messaging platform 220 in accordance with particular regulations (e.g., HIPAA regulations).

In some implementations, in order to access the secure messaging service, the user may utilize user device 210 to access a web page provided by secure messaging platform 220. The web page may ask the user to provide credentials (e.g., a user name and password) for accessing the secure messaging service. The user may input the credentials, and may select a mechanism (e.g., a button, an icon, a link, a menu item, etc.) provided by the web page that, when selected, may indicate that the user wants to access the secure messaging service. If the user selects the mechanism, via user device 210, a request to access the secure messaging service may be generated by user device 210 and provided to secure messaging platform 220. The request to access the secure messaging service may include the credentials associated with the user. Secure messaging platform 220 may receive the request to access the secure messaging service and the credentials associated with the user.

As further shown in FIG. 6A, process 600 may include authenticating the user based on credentials provided in the request (block 610). For example, secure messaging platform 220 may utilize the user credentials, provided with the request to access the secure messaging service, to authenticate the user. In some implementations, secure messaging platform 220 may compare the user credentials with credential information stored in repository 230. For example, if the user provided a user name and a password with the request to access, secure messaging platform 220 may compare the user name and the password with user names and passwords (e.g., stored in repository 230) of users registered with secure messaging platform 220. In this example, secure messaging platform 220 may determine whether the user name and password, provided by the user, match a user name and a password stored in repository 230. The user names and passwords stored in repository 230 may be associated with users that executed platform use agreements and created profiles with secure messaging platform 220.

If secure messaging platform 220 determines that the user name and password, provided by the user, match a user name and a password stored in repository 230, secure messaging platform 220 may authenticate the user. In some implementations, secure messaging platform 220 may determine that the user is an authentic doctor based on the user name and the password provided in the request to access the secure messaging platform. If secure messaging platform 220 determines that the user name and password, provided by the user, do not match a user name and a password stored in repository 230, secure messaging platform 220 may not authenticate the user, and may deny access to the unauthenticated user.

As further shown in FIG. 6A, process 600 may include receiving a search request for a particular entity from the first user device (block 615). For example, the user may wish to securely send a message to another user via secure messaging platform 220. In some implementations, secure messaging platform 220 may provide, to user device 210, a user interface that lists actions that may be performed by the user via secure messaging platform 220. For example, the user interface may include options enabling the user to send a message to one or more other users of secure messaging platform 220, post information to a message board, edit information associated with the user's profile, search for users of secure messaging platform 220 to which to send a message, read messages received by the user via secure messaging platform, etc.

If the user selects the option to search for users of secure messaging platform 220 to which to send a message, secure messaging platform 220 may provide, to user device 210, a search user interface. The search user interface may include one or more fields requesting information for performing a search for users of secure messaging platform 220. In some implementations, the search user interface may include a field requesting a user name, a field requesting a user title (e.g., doctor, hospital administrator, etc.), a field requesting a user address, a field requesting a user specialty (e.g., surgeon, family doctor, etc.), etc. The user may provide, via user device 210, the information requested by the search user interface, and may select a mechanism (e.g., a button, an icon, a link, a menu item, etc.) that, when selected, may provide the information to secure messaging platform 220. Secure messaging platform 220 may receive the information provided via the search user interface.

As further shown in FIG. 6A, process 600 may include identifying authentic platform user(s) based on the search request (block 620). For example, secure messaging platform 220 may identify one or more users of secure messaging platform 220 based on the search request provided by the user. In some implementations, secure messaging platform 220 may compare the information provided via the search user interface with information (e.g., user profile information) stored in repository 230 in order to identify one or more users of secure messaging platform 220. For example, if the user provides a name (e.g., John Smith) and a title (e.g., orthopedic surgeon) via the search user interface, secure messaging platform 220 may search repository 230 for orthopedic surgeons named John Smith. If repository 230 includes three users named John Smith, and who are orthopedic surgeons, secure messaging platform 220 may identify the three users as matches for the search request provided by the user.

In some implementations, secure messaging platform 220 may rank the identified users based on a degree of matching between the information provided via the search user interface and the user profile information stored in repository 230. For example, assume that secure messaging platform 220 identifies three users named John Smith. Further, assume that the first user is a doctor, the second user is a surgeon but not an orthopedic surgeon, and the third user is an orthopedic surgeon. In this example, secure messaging platform 220 may rank the third user higher than the first user and the second user, and may rank the second user higher than the first user.

As further shown in FIG. 6A, process 600 may include providing information associated with the identified platform user(s) to the first user device (block 625). For example, secure messaging platform 220 may provide, to user device 210, information associated with the identified user(s) of secure messaging platform 220. In some implementations, secure messaging platform 220 may provide, to user device 210, a user interface that includes a ranked list or an unranked list of users of secure messaging platform 220 that are identified based on the search request. In some implementations, the ranked list of users may include names of the users, profile information (e.g., an address, a hospital affiliation, etc.) associated with the users, etc.

In some implementations, the user of user device 210 may select a particular user from the users provided in the list. When the user selects the particular user, secure messaging platform 220 may provide, to user device 210, a message user interface. The message user interface may include a field for identifying a recipient of the message, a field for inputting text for the message, a field for attaching one or more files (e.g., images, videos, audio files, documents, reports, etc.), etc. In some implementations, the message user interface may provide the particular user's name in the field for identifying the recipient of the message.

In some implementations, rather than selecting the option to search for users of secure messaging platform 220, the user may select the option to send a message to a user of secure messaging platform 220. Secure messaging platform 220 may provide the message user interface to user device 210 when the user selects the option to send a message. As the user begins inputting the name of the recipient in the field for identifying the recipient, secure messaging platform 220 may perform a search for users matching the partially input recipient name. Secure messaging platform 220 may provide (e.g., in the field for identifying the recipient) a list of recommended users for the recipient based on the search. The user may select one of the recommended users or may continue to input the recipient name. If the user continues to input the recipient name, secure messaging platform 220 may modify the search for users matching the partially input recipient name, and may display a modified list of recommended users based on the modified search.

As further shown in FIG. 6A, process 600 may include receiving a message, addressed to a particular user of the identified user(s), from the first user device (block 630). For example, the user, via user device 210, may utilize the message user interface to provide text in the field for inputting text, and to attach one or more files to the message. In some implementations, the user may instruct user device 210 to provide the message, generated by the message user interface, to secure messaging platform 220, and secure messaging platform 220 may receive the message. For example, the user may select a mechanism (e.g., a Send Message button) that, when selected, may instruct user device 210 to provide the message to secure messaging platform 220. In some implementations, the message may be addressed to the particular user and may include one or more attached files and a message to the particular user. For example, if the particular user is an orthopedic surgeon named John Smith, the message may be addressed to John Smith and may include an attachment (e.g., an X-ray of a patient). The message may also include textual information, such as, for example, “Dear Dr. John Smith, attached is the X-ray of your patient that you requested.”

As further shown in FIG. 6A, process 600 may include analyzing the message to determine information that may be used for identifying the user and/or the particular user (block 635). For example, secure messaging platform 220 may analyze the content of the message, including any attached files, to determine if the content includes information that may be used to identify the user and/or the particular user in the future. In some implementations, secure messaging platform 220 may analyze the textual information provided in the message to determine whether the textual information includes information that may be used to identify the user and/or the particular user. For example, if the textual information includes a signature block for the user (e.g., that includes a title, an address, a hospital affiliation, etc.), secure messaging platform 220 may determine that the signature block may be used to identify the user.

In some implementations, secure messaging platform 220 may analyze information associated with the attached files to determine whether the attached files include information that be used to identify the user and/or the particular user. For example, if an attached file is an X-ray image, secure messaging platform 220 may perform OCR on the image and may analyze the processed image. In this example, the X-ray image may include a patient name, a patient birth date, a hospital number, a hospital name, etc. Secure messaging platform 220 may determine that such information may be used to identify the user and/or the particular user. For example, secure messaging platform 220 may determine that the user and/or the particular user are associated with the patient name, the patient birth date, the hospital number, and/or the hospital name.

As shown in FIG. 6B, process 600 may include storing the information that may be used for identifying the user and/or the particular user (block 640). For example, secure messaging platform 220 may associate and store (e.g., in repository 230) the determined information (e.g., information that may be used to identify the user and/or the particular user in the future) with the profiles of the user and/or the particular user. In some implementations, secure messaging platform 220 may associate and store, with the profiles, the determined information that is not already included in the profiles. For example, if the signature block of the message includes a name, a title, and an address of the user and the user's profile includes the user's name and address, secure messaging platform 220 may only associate the title with the user's profile.

In some implementations, secure messaging platform 220 may utilize the determined information to authenticate the user and/or the particular user at a later time. For example, secure messaging platform 220 may utilize a variety of factors to authenticate a user, such as a user name and password of the user, a location of user device 210, an Internet protocol (IP) address associated with user device 210, a name of the user, an address of the user, etc. The determined information may be added to the variety of factors that may be used to authenticate the user. For example, if the determined information includes the user's title, secure messaging platform 220 may add the user's title to the factors that may be used to authenticate the user. In some implementations, the more items of the determined information that match the factors, the stronger the authentication of the user.

As further shown in FIG. 6B, process 600 may include encrypting the message and formatting the message to a format understood by a second user device associated with the particular user (block 645). For example, secure messaging platform 220 may encrypt the message, and the attached files, so that unauthorized parties cannot read the message but authorized parties can read the message. In some implementations, secure messaging platform 220 may utilize an encryption scheme (e.g., symmetric-key encryption, public-key encryption, etc.) that encrypts the message using an encryption algorithm that transforms the message into unreadable information.

In some implementations, secure messaging platform 220 may format the message, and the attached files, into a format that is understood by a user device 210 associated with the particular user. For example, assume that an attached file is an electronic health record (EHR) in a first format understood by user device 210 associated with the user. However, user device 210 associated with the particular user may accept EHRs with a second format, different than the first format. In this example, secure messaging platform 220 may format the EHR into the second format that is understood by user device 210 associated with the particular user. In another example, assume that the particular user receives messages from secure messaging platform 220 as text messages on user device 210. In this example, secure messaging platform 220 may format the message into a text message format (e.g., a Short Message Service (SMS) message format) so that the particular user may receive the message as a text message on user device 210.

As further shown in FIG. 6B, process 600 may include providing, to the second user device, a notification indicating that there is a message for the particular user (block 650). For example, if the particular user is logged into the secure messaging service, secure messaging platform 220 may provide, to user device 210 of the particular user and via the secure messaging service, a notification indicating that there is a message for the particular user. In some implementations, the notification may include a mechanism (e.g., a window, a banner, an icon, a button, a link, etc.) that may be highlighted in some manner (e.g., via blinking text, different color text, different sized text, etc.) to indicate that there is a message for the particular user. For example, if the particular user is logged into the secure messaging service, textual information may be provided in user interface(s) of the secure messaging service. The textual information may include a number of messages that have not been read by the particular user (e.g., “You have 5 unread messages”).

In some implementations, if the particular user is not logged into the secure messaging service, secure messaging platform 220 may provide the notification to the particular user via other mechanisms. For example, secure messaging platform 220 may provide the notification indicating that there is a message for the particular user via a text message, an email message, an instant message, a voicemail message, etc. provided to user device 210 of the particular user.

As further shown in FIG. 6B, process 600 may include receiving a request to access the secure messaging platform from the second user device (block 655). For example, based on the notification, the particular user may wish to access the secure messaging service in order to retrieve the message. In some implementations, in order to access the secure messaging service, the particular user may utilize user device 210 to access a web page provided by secure messaging platform 220. The web page may ask the particular user to provide credentials (e.g., a user name and password) for accessing the secure messaging service. The particular user may input the credentials, and may select a mechanism (e.g., a button, an icon, a link, a menu item, etc.) provided by the web page that, when selected, may indicate that the user wants to access the secure messaging service. If the particular user selects the mechanism, via user device 210, a request to access the secure messaging service may be generated by user device 210 and provided to secure messaging platform 220. The request to access the secure messaging service may include the credentials associated with the particular user. Secure messaging platform 220 may receive the request to access the secure messaging service and the credentials associated with the particular user.

As further shown in FIG. 6B, process 600 may include authenticating the particular user based on credentials provided in the request (block 660). For example, secure messaging platform 220 may utilize the particular user credentials, provided with the request to access the secure messaging service, to authenticate the particular user. In some implementations, secure messaging platform 220 may compare the particular user credentials with credential information stored in repository 230. For example, if the user provided a user name and a password with the request to access, secure messaging platform 220 may compare the user name and the password with user names and passwords (e.g., stored in repository 230) of users registered with secure messaging platform 220. In this example, secure messaging platform 220 may determine whether the user name and password, provided by the particular user, match a user name and a password stored in repository 230. If secure messaging platform 220 determines that the user name and password, provided by the particular user, match a user name and a password stored in repository 230, secure messaging platform 220 may authenticate the particular user.

As further shown in FIG. 6B, process 600 may include providing the encrypted and formatted message to the second user device (block 665). For example, after the particular user is authenticated, secure messaging platform 220 may provide the encrypted and formatted message to user device 210 associated with the particular user. In some implementations, secure messaging platform 220 may provide, to user device 210, a user interface that enables the particular user to read the message. In some implementations, user device 210 may receive the message, may decrypt the message, and may display the message to the particular user. The particular user may review the message, and may review and/or store the attached file(s).

Although FIGS. 6A and 6B show example blocks of process 600, in some implementations, process 600 may include additional blocks, fewer blocks, different blocks, or differently arranged blocks than those depicted in FIGS. 6A and 6B. Additionally, or alternatively, two or more of the blocks of process 600 may be performed in parallel.

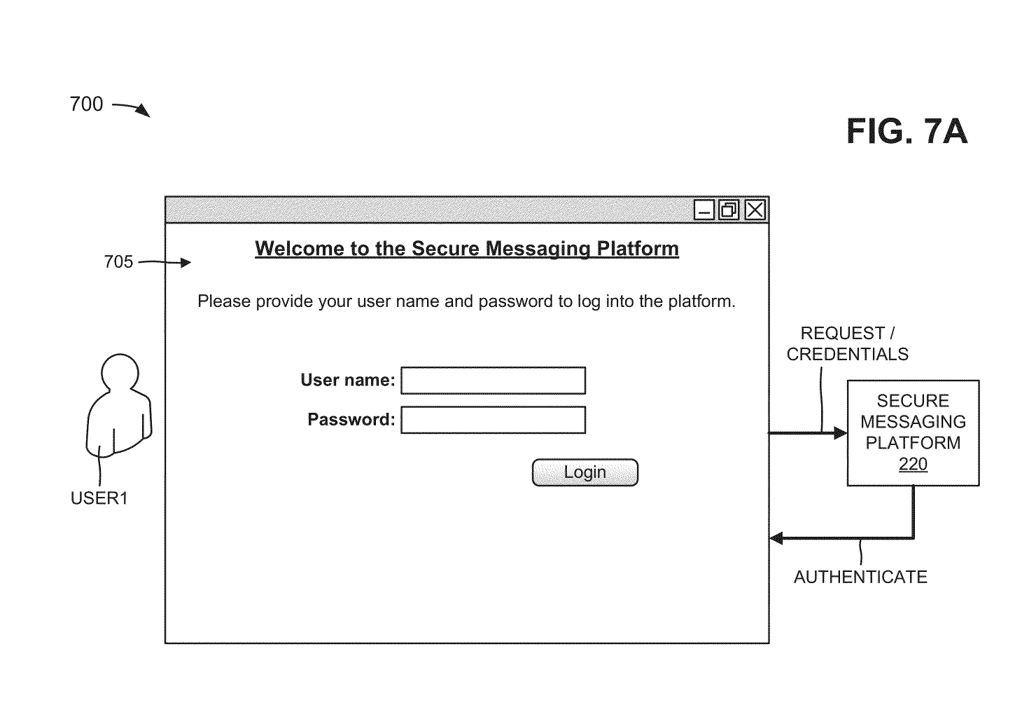

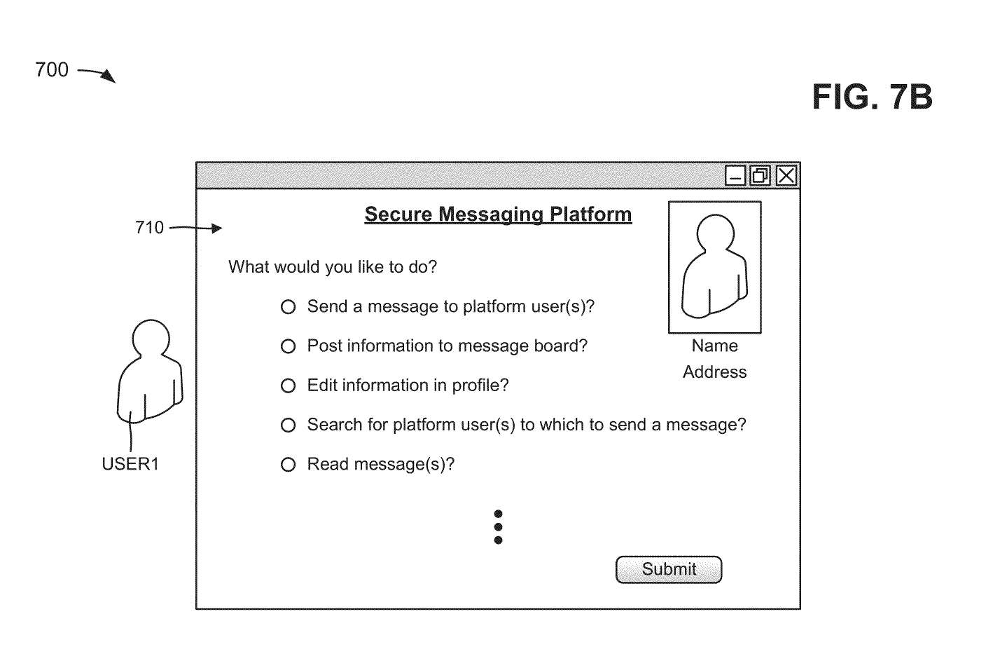

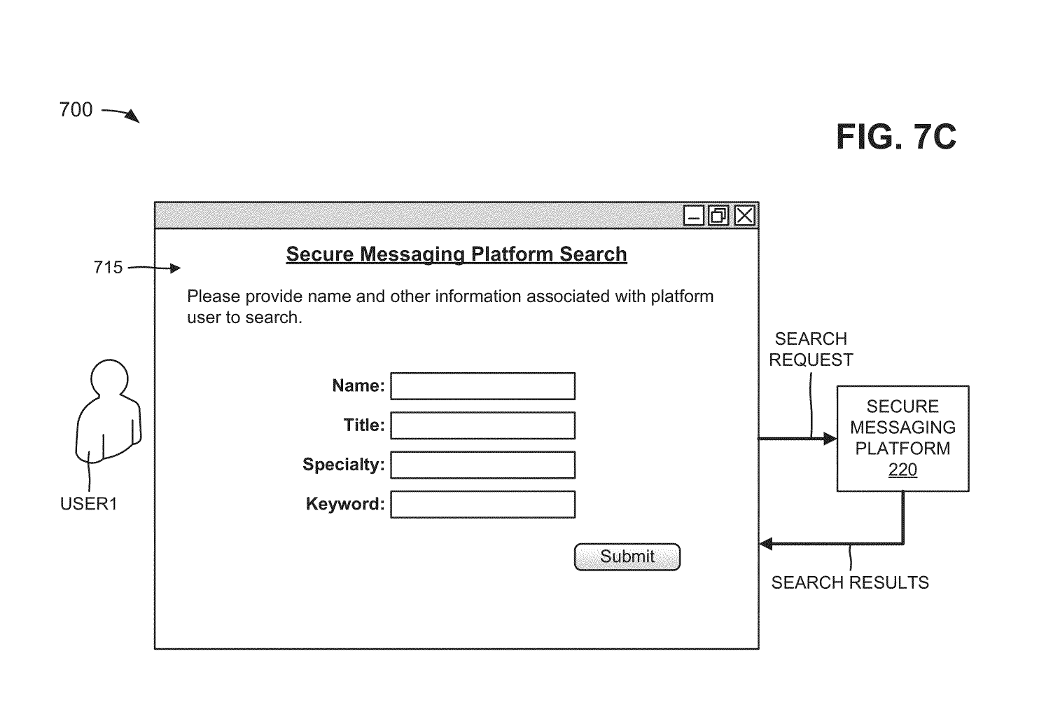

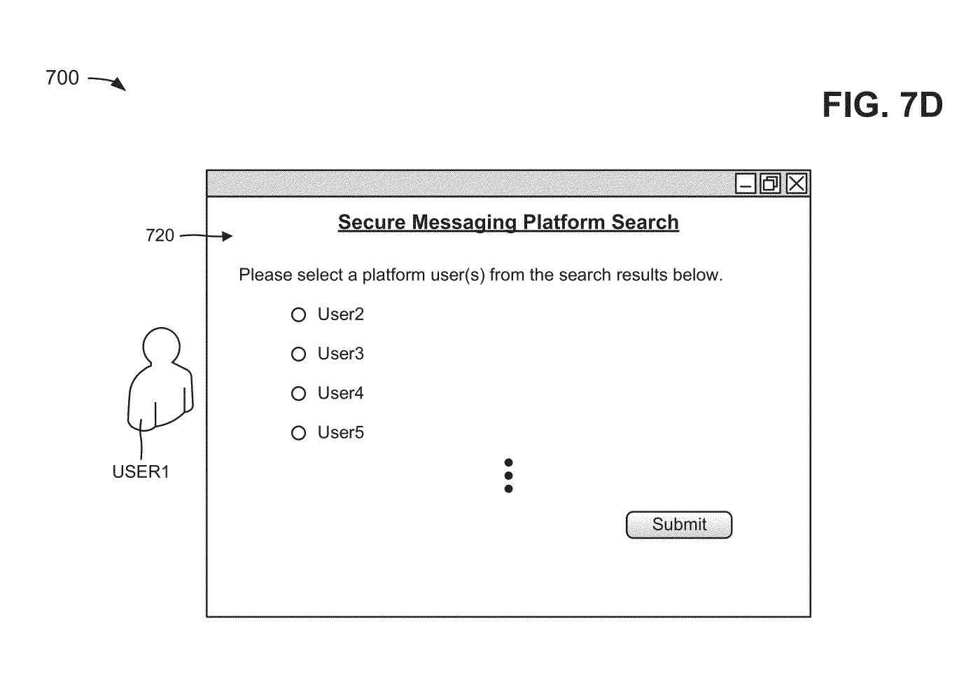

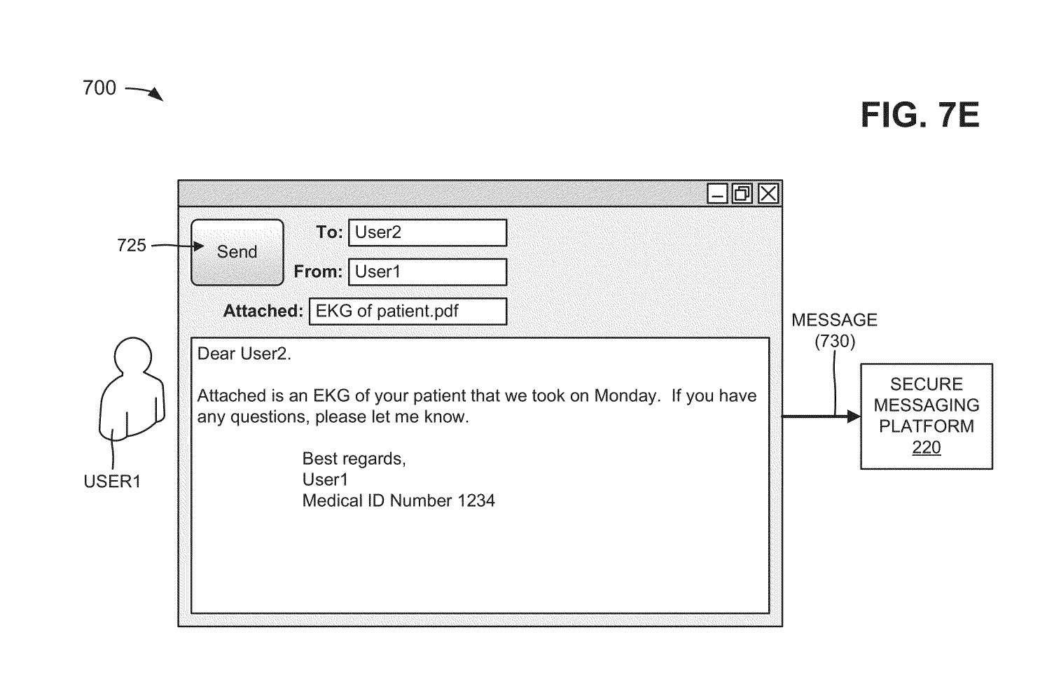

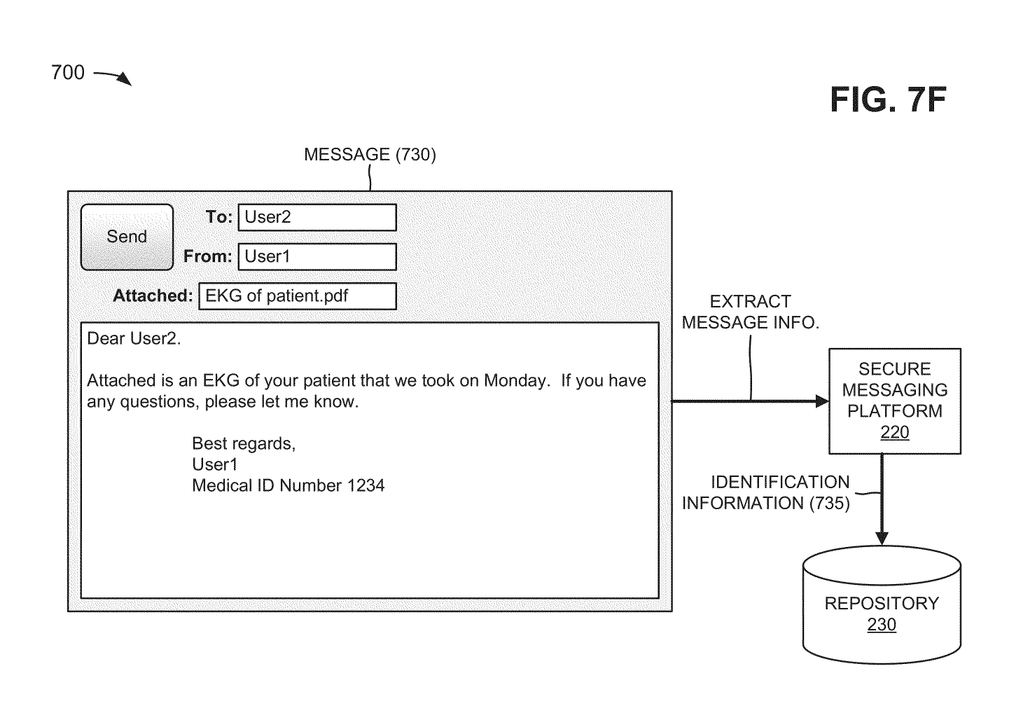

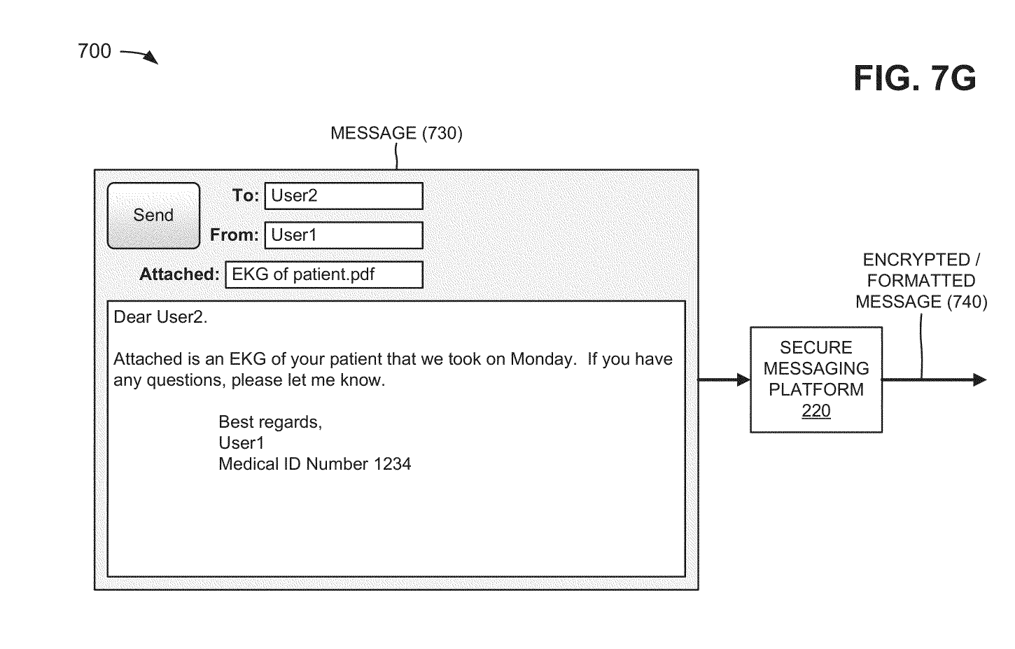

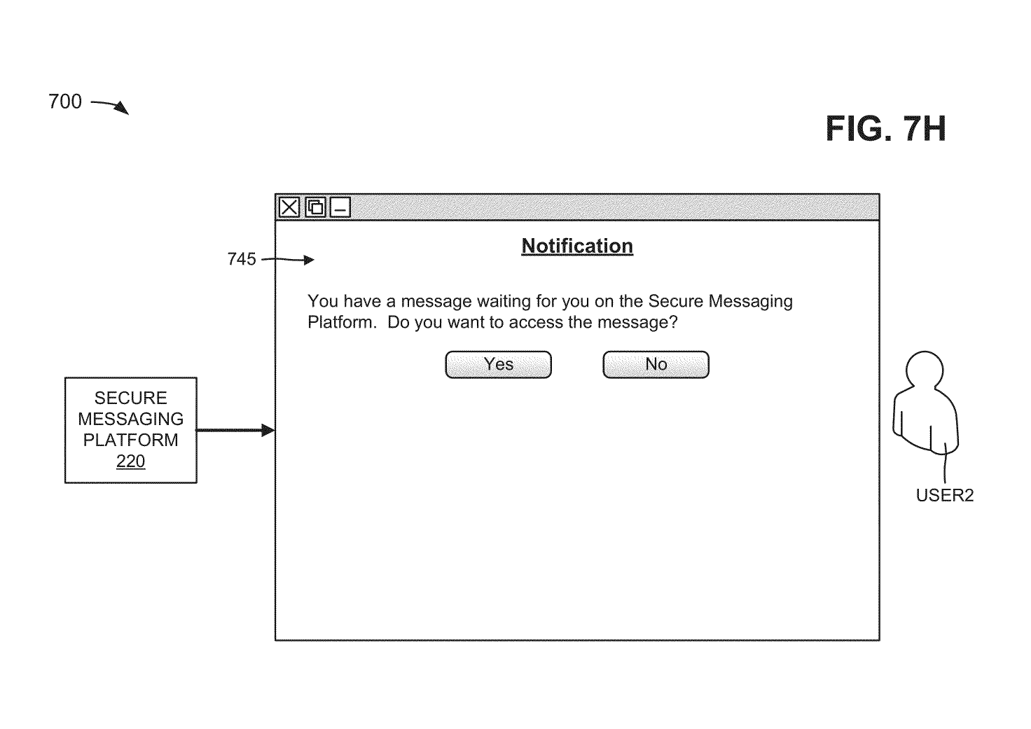

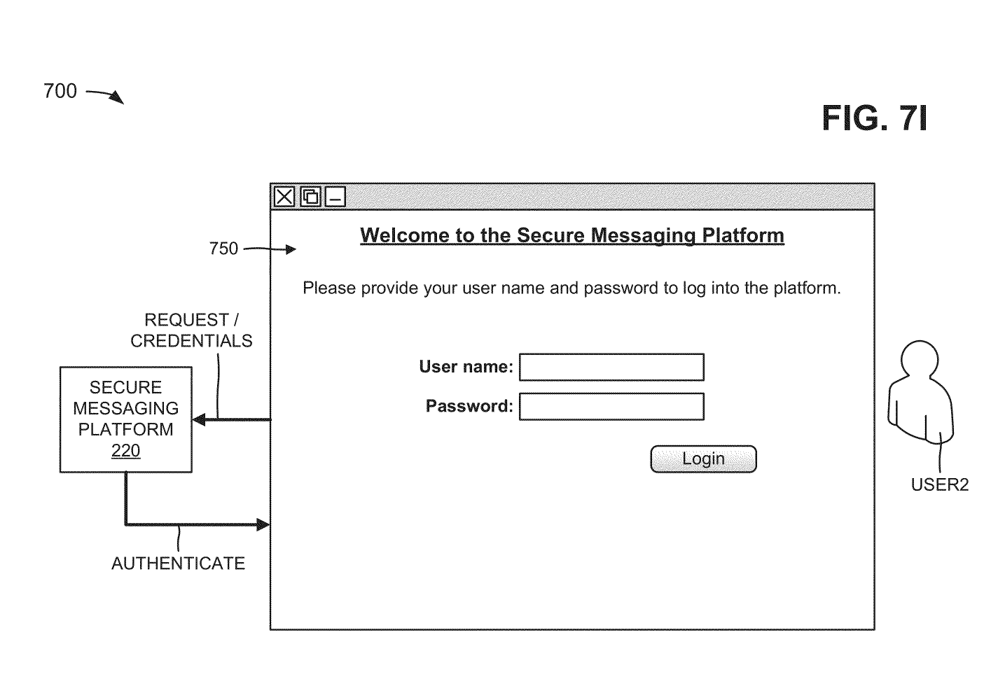

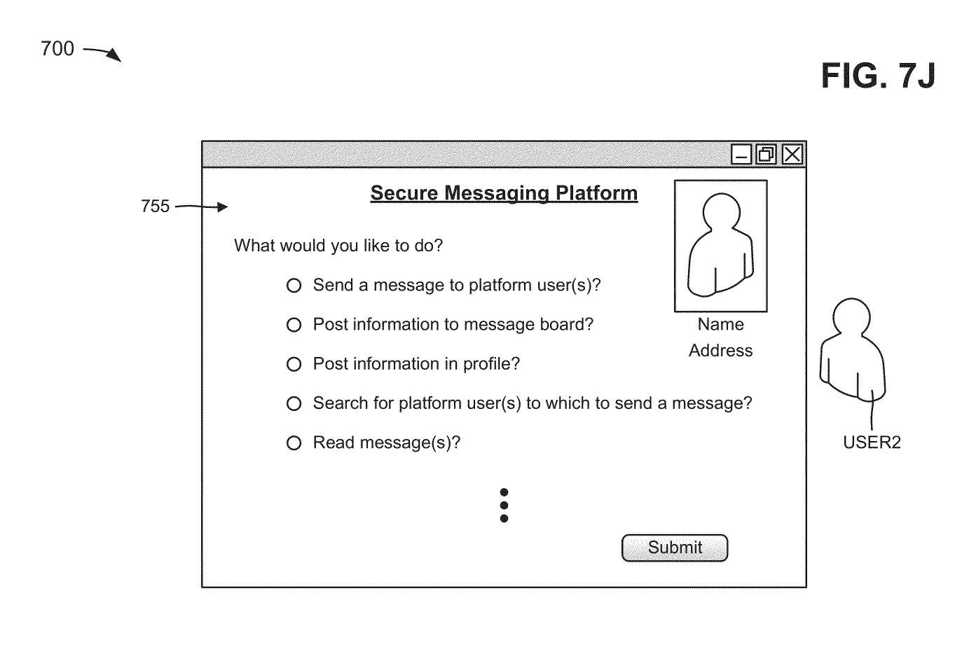

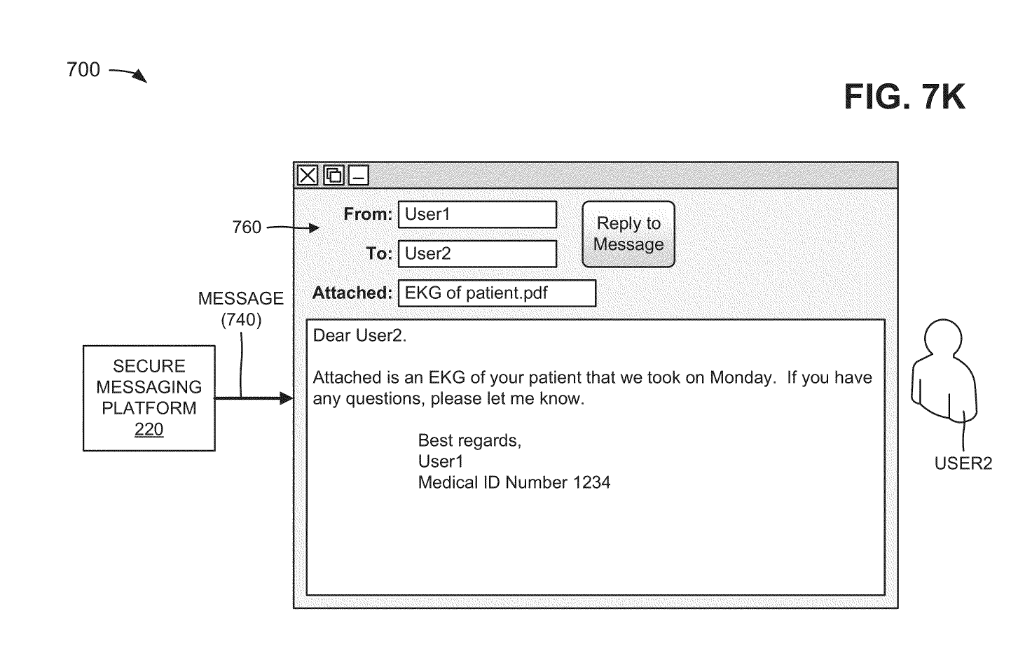

FIGS. 7A-7K are diagrams of an example 700 relating to example process 600 shown in FIGS. 6A and 6B. In example 700, assume that a first user (e.g., User1, such as a first doctor) is associated with a first user device 210, and utilizes the first user device 210 to access secure messaging platform 220. As shown in FIG. 7A, assume that secure messaging platform 220 provides a user interface 705 to the first user device 210, and the first user device 210 displays user interface 705 to the first user. User interface 705 may request that the first user provide credentials, such as a user name and a password, in order to access secure messaging platform 220. Assume that the first user inputs a user name and a password, and selects a Login button provided by user interface 705. Selection of the Login button may cause the first user device 210 to provide a request and credentials to secure messaging platform 220, as further shown in FIG. 7A. The request may include a request to access the secure messaging service and the credentials may include the user name and password input by the first user.

Secure messaging platform 220 may receive the request and the credentials, and may authenticate the first user based on the credentials, as further shown in FIG. 7A. After the first user is authenticated, secure messaging platform 220 may provide a user interface 710 to the first user device 210, and the first user device 210 may display user interface 710 to the first user, as shown in FIG. 7B. User interface 710 may include a list of actions that may be performed by the first user via secure messaging platform 220, such as, for example, sending a message to platform user(s), posting information to message board, editing information in profile, searching for platform user(s) to which to send a message, reading message(s), etc. In example 700, assume that the first user selects “Search for platform user(s) to which to send a message” as the action to be performed, and selects a Submit button.

Selection of the Submit button may cause secure messaging platform 220 to provide a user interface 715 to the first user device 210, as shown in FIG. 7C. The first user device 210 may display user interface 715 to the first user. User interface 715 may request that the first user input a name and other information (e.g., a patient name, a hospital name, a title, an address, a specialty, etc.) associated with a platform user to search. In example 700, assume that the first user inputs the name and other information and selects a Submit button. When the user selects the Submit button, the first user device 210 may provide a search request, with the input name and other information, to secure messaging platform 220, as further shown in FIG. 7C. Secure messaging platform 220 may perform a search for platform user(s) based on the search request and the name and other information provided by the first user. The search may generate search results, and secure messaging platform 220 may provide the search results to the first user device 210, as further shown in FIG. 7C.

In example 700, assume that secure messaging platform 220 provides the search results, via a user interface 720, to the first user device 210, and that the first user device 210 displays user interface 720 to the first user, as shown in FIG. 7D. User interface 720 may include a ranked list or an unranked list of platform users that match the name and other information provided by the user. For example, user interface 720 may include a partial profile (e.g., a name, a specialty, a hospital name, search information, etc.) of a second user (User2, such as a second doctor), a partial profile of a third user (User3), a partial profile of a fourth user (User4), a partial profile of a fifth user (User5), etc. of secure messaging platform 220. In example 700, assume that the first user selects the partial profile of the second user and selects a Submit button.

When the user selects the Submit button, secure messaging platform 220 may provide a user interface 725 to the first user device 210, and the first user device 210 may display user interface 725 to the first user, as shown in FIG. 7E. User interface 725 may include information that enables the first user to create a secure message 730 addressed to the second user. As shown, user interface 725 may include a To field, a From field, an Attached field, and a section in which a textual message may be provided. In example 700, assume that secure messaging platform 220 automatically populates the To field with the name of the second user, and automatically populates the From field with the name of the first user. Further, assume that the first user utilizes the first user device 210 to attach an image (e.g., a PDF image of a patient's electrocardiogram or EKG) to message 730, as shown in the Attached field. The first user may provide a textual message in the section, such as, for example: “Dear User2. Attached is an EKG of your patient that we took on Monday. If you have questions, please let me know.” When the first user is finished creating message 730, the first user may select a Send button, as further shown in FIG. 7E. When the user selects the Send button, the first user device 210 may provide the created message 730 to secure messaging platform 220, as further shown in FIG. 7E.

In some implementations, secure messaging platform 220 may extract message information from message 730, as shown in FIG. 7F. For example, secure messaging platform 220 may extract the text provided in the textual section of message 730, and may extract text (e.g., after performing OCR) from the image of the patient's EKG. Secure messaging platform 220 may analyze the extracted information and may determine if any of the extracted information may be used to identify the first user or the second user. For example, secure messaging platform 220 may determine that the Medical ID Number provided by the first user in the textual section may be used to identify the first user. In another example, secure messaging platform 220 may determine that the patient's EKG includes information (e.g., a hospital name, a hospital number, etc.) that may be used to identify the first user and the second user. Secure messaging platform 220 may provide such identification information 735 to repository 230 for storage, as further shown in FIG. 7F.

Secure messaging platform 220 may encrypt and format message 730 to create an encrypted/formatted message 740, as shown in FIG. 7G. For example, secure messaging platform 220 may encrypt message 730 so that unauthorized parties cannot read encrypted/formatted message 740 but the second user, via a second user device 210, can read encrypted/formatted message 740. Secure messaging platform 220 may format message 730 into a format such that encrypted/formatted message 740 may be understood by the second user device 210 associated with the second user.

After encrypting and formatting message 730 to create encrypted/formatted message 740, secure messaging platform 220 may provide a notification, via a user interface 745, to the second user device 210, as shown in FIG. 7H. The second user device 210 may display user interface 745 to the second user, as further shown in FIG. 7H. In some implementations, secure messaging platform 220 may provide user interface 745 to the second user device 210 even if the second user is not logged into secure messaging platform 220. User interface 745 may state that the second user has a message waiting on secure messaging platform 220, and may inquire whether the second user wants to access the message. In example 700, assume that the second user wants to access the message and selects a Yes button to indicate that the desires to access the message. Further, assume that the second user is not logged into secure messaging platform 220.

When the second user selects the Yes button, secure messaging platform 220 may provide a user interface 750 to the second user device 210, and the second user device 210 may display user interface 750 to the second user, as shown in FIG. 7I. User interface 750 may request that the second user provide credentials, such as a user name and a password, in order to access secure messaging platform 220. Assume that the second user inputs a user name and a password, and selects a Login button provided by user interface 750. Selection of the Login button may cause the second user device 210 to provide a request and credentials to secure messaging platform 220, as further shown in FIG. 7I. The request may include a request to access the secure messaging service and the credentials may include the user name and password input by the second user.

Secure messaging platform 220 may receive the request and the credentials, and may authenticate the second user based on the credentials, as further shown in FIG. 7I. After the second user is authenticated, secure messaging platform 220 may provide a user interface 755 to the second user device 210, and the second user device 210 may display user interface 755 to the second user, as shown in FIG. 7J. User interface 755 may include a list of actions that may be performed by the second user via secure messaging platform 220, such as, for example, sending a message to platform user(s), posting information to message board, editing information in profile, searching for platform user(s) to which to send a message, reading message(s), etc. In example 700, assume that the second user selects “Read message(s)” as the action to be performed, and selects a Submit button.

Selection of the Submit button may cause secure messaging platform 220 to provide a user interface 760 to the second user device 210, as shown in FIG. 7K. The second user device 210 may display user interface 760 to the second user. User interface 760 may include the information associated with encrypted/formatted message 740. As shown in FIG. 7K, user interface 760 may include a From field, a To field, an Attached field, and a section in which a textual message may be provided. As described above, the To field may include the name of the first user, the From field may include the name of the second user, and the PDF image of the patient's EKG may be shown in the Attached field. The textual message provide by the first user may be provided in the section. The second user may review the information provided by user interface 760, including the PDF image of the patient's EKG. In some implementations, the second user may reply to the message provided by user interface 760 by selecting a Reply to Message button, as further shown in FIG. 7K. If the second user selects the Reply to Message button, secure messaging platform 220 may provide a user interface, similar to user interface 725 (FIG. 7E), to the second user device 210, and the second user device 210 may display the user interface to the second user. In some implementations, the second user may instruct the second user device 210 to store the message and/or the attached EKG with information associated with the patient.

As indicated above, FIGS. 7A-7K are provided merely as an example. Other examples are possible and may differ from what was described with regard to FIGS. 7A-7K.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

The foregoing disclosure provides illustration and description, but is not intended to be exhaustive or to limit the implementations to the precise form disclosed. Modifications and variations are possible in light of the above disclosure or may be acquired from practice of the implementations.

A component is intended to be broadly construed as hardware, firmware, or a combination of hardware and software.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A method, comprising:
receiving, by a device and from a user of a first user device, a request to access a secure messaging service,
the request including credentials associated with the user, and
the secure messaging service being provided by the device;
authenticating, by the device, the user based on the credentials provided in the request;
receiving, by the device and from the first user device, a search request for one or more users of the secure messaging service;
identifying, by the device, one or more authentic users of the secure messaging service based on the search request,
the one or more authentic users including one or more users that are registered with the secure messaging service;
providing, by the device and to the first user device, information associated with the one or more authentic users of the secure messaging service;
receiving, by the device and from the first user device, a message addressed to a particular user of the one or more authentic users;
analyzing, by the device, the message to determine whether the message includes information for identifying the user or the particular user at a later time;
storing, by the device, the information for identifying the user or the particular user when the message includes the information for identifying the user or the particular user;
formatting, by the device, the message into a format that is understood by a second user device associated with the particular user;
encrypting, by the device, the formatted message to create an encrypted and formatted message; and
providing, by the device, the encrypted and formatted message to the second user device.

2. The method of claim 1, further comprising:
providing, to the second user device, a notification indicating that the encrypted and formatted message is provided on the secure messaging service;
receiving, based on the notification and from the second user device, another request to access the secure messaging service,
the other request including credentials associated with the particular user;
authenticating the particular user based on the credentials provided in the other request; and
providing the encrypted and formatted message to the second user device after the particular user is authenticated.

3. The method of claim 1, where:
the user is a first healthcare provider,
the particular user is a second healthcare provider, and
the message includes healthcare information.

4. The method of claim 3, where the message includes an electronic health record (EHR) associated with a patient of the first healthcare provider or the second healthcare provider.

5. The method of claim 1, further comprising:
receiving, via the first user device, a request to join the secure messaging service from the user,
the request to join being received before the request to access the secure messaging service is received from the first user device;
providing a platform use agreement to the first user device based on the request to join;
receiving an executed platform use agreement from the first user device; and
creating a profile for the user, for the secure messaging service, based on the receiving of the executed platform use agreement.

6. The method of claim 5, further comprising:
providing, for display, a first user interface that enables the user to provide profile information for the profile of the user;
receiving the profile information via the first user interface; and
associating the profile information with the profile of the user.

7. The method of claim 6, further comprising:
providing, for display, a second user interface that enables the user to define message rules for the profile of the user;
receiving the message rules via the second user interface; and
associating the message rules with the profile of the user.

8. A device that provides secure messaging service, the device comprising:
one or more processors to:
receive, from a first user device associated with a user, a request to access the secure messaging service,
the request including credentials associated with the user,
authenticate the user based on the credentials provided in the request,
receive, from the first user device, a search request for one or more users of the secure messaging service,
identify one or more authentic users of the secure messaging service based on the search request,
the one or more authentic users including one or more users that are registered with the secure messaging service,
provide, to the first user device, information associated with the one or more authentic users of the secure messaging service,
receive, from the first user device, a message addressed to a particular user of the one or more authentic users,
analyze the message to determine whether the message includes information for identifying the user or the particular user at a later time,
store the information for identifying the user or the particular user when the message includes the information for identifying the user or the particular user,
format the message into a format that is understood by a second user device associated with the particular user,
encrypt the formatted message to create an encrypted and formatted message, and
provide the encrypted and formatted message to the second user device.

9. The device of claim 8, where the one or more processors are further to:
provide, to the second user device, a notification indicating that the encrypted and formatted message is provided on the secure messaging service,
receive, based on the notification and from the second user device, another request to access the secure messaging service,
the other request including credentials associated with the particular user,
authenticate the particular user based on the credentials provided in the other request, and
provide the encrypted and formatted message to the second user device after the particular user is authenticated.

10. The device of claim 8, where:
the user is a first healthcare provider,
the particular user is a second healthcare provider, and
the message includes an electronic health record (EHR) associated with a patient of the first healthcare provider or the second healthcare provider.

11. The device of claim 8, where the one or more processors are further to:
receive, via the first user device, a request to join the secure messaging service from the user,
the request to join being received before the request to access the secure messaging service is received from the first user device,
provide a platform use agreement to the first user device based on the request to join,
receive an executed platform use agreement from the first user device, and
create a profile for the user, for the secure messaging service, based on the receiving of the executed platform use agreement.

12. The device of claim 11, where the one or more processors are further to:
provide, for display, a first user interface that enables the user to provide profile information for the profile of the user,
receive the profile information via the first user interface, and
associate the profile information with the profile of the user.

13. The device of claim 12, where the one or more processors are further to:
provide, for display, a second user interface that enables the user to define message rules for the profile of the user,
receive the message rules via the second user interface, and
associate the message rules with the profile of the user.

14. The device of claim 13, where the message rules define from which of the one or more authentic users that the user is to receive messages via the secure messaging service.

15. A non-transitory computer-readable medium for storing instructions, the instructions comprising:
one or more instructions that, when executed by one or more processors of a device that provides a secure messaging service, cause the one or more processors to:
receive, from a first user device associated with a user, a request to access the secure messaging service,
the request including credentials associated with the user,
authenticate the user based on the credentials provided in the request,
receive, from the first user device, a search request for one or more users of the secure messaging service,
identify one or more authentic users of the secure messaging service based on the search request,
the one or more authentic users including one or more users that are registered with the secure messaging service,
provide, to the first user device, information associated with the one or more authentic users of the secure messaging service,
receive, from the first user device, a message addressed to a particular user of the one or more authentic users,
analyze the message to determine whether the message includes information for identifying the user or the particular user at a later time,
store the information for identifying the user or the particular user when the message includes the information for identifying the user or the particular user,
format the message into a format that is understood by a second user device associated with the particular user,
encrypt the formatted message to create an encrypted and formatted message, and
provide the encrypted and formatted message to the second user device.

16. The computer-readable medium of claim 15, where the instructions further comprise:
one or more instructions that, when executed by the one or more processors, cause the one or more processors to:
provide, to the second user device, a notification indicating that the encrypted and formatted message is provided on the secure messaging service,
receive, based on the notification and from the second user device, another request to access the secure messaging service,
the other request including credentials associated with the particular user,
authenticate the particular user based on the credentials provided in the other request, and
provide the encrypted and formatted message to the second user device after the particular user is authenticated.

17. The computer-readable medium of claim 15, where:
the user is a first healthcare provider,
the particular user is a second healthcare provider, and
the message includes an electronic health record (EHR) associated with a patient of the first healthcare provider or the second healthcare provider.

18. The computer-readable medium of claim 15, where the instructions further comprise:
one or more instructions that, when executed by the one or more processors, cause the one or more processors to:
receive, via the first user device, a request to join the secure messaging service from the user,
the request to join being received before the request to access the secure messaging service is received from the first user device,
provide a platform use agreement to the first user device based on the request to join,
receive an executed platform use agreement from the first user device, and
create a profile for the user, for the secure messaging service, based on the receiving of the executed platform use agreement.

19. The computer-readable medium of claim 18, where the instructions further comprise:
one or more instructions that, when executed by the one or more processors, cause the one or more processors to:
provide, for display, a first user interface that enables the user to provide profile information for the profile of the user,
receive the profile information via the first user interface, and
associate the profile information with the profile of the user.

20. The computer-readable medium of claim 19, where the instructions further comprise:
one or more instructions that, when executed by the one or more processors, cause the one or more processors to:
provide, for display, a second user interface that enables the user to define message rules for the profile of the user,
receive the message rules via the second user interface, and
associate the message rules with the profile of the user.
